(19) United States
(12) Patent Application Publication
(10) Pub. No.: US 2004/0113623 A1
(43) Pub. Date: Jun. 17, 2004

(54) System for detecting optically invisible objects provided with encoding

(76) Inventor: Fabien Belloir, Trepail (FR)

Correspondence Address: CANTOR COLBURN, LLP, 55 GRIFFIN ROAD SOUTH, BLOOMFIELD, CT, 06002

(21) Appl. No.: 10/250,377

(22) PCT Filed: Dec. 26, 2001
(86) PCT No.: PCT/FR01/04207

(30) Foreign Application Priority Data
Dec. 28, 2000 (FR) 00/17248

(51) Int. Cl. G01V 3/08

(52) U.S. Cl. 324/326; 324/329

(57) ABSTRACT

The invention concerns a system for detecting and identifying optically invisible objects, provided with encoding, wherein each object (2) is provided with encoding elements in the form of a series of thin electrically conductive elements (3, 4, 5), capable of being detected by electromagnetic process, forming each a surface of predetermined dimensions and arranged in or on an electrically insulating protective support, said elements being spaced apart from one another by intervals likewise of predetermined value. It comprises an electromagnetic detector (8) including at least an emitting coil and a reception coil, designed to deliver to the detector at least two signals of the code borne by an object and its surroundings, means being provided for processing said signals so as to reproduce the signature of the single code and thereby locate and identify the encoded object.

The subject of the present invention is a system for detecting and identifying optically invisible objects which are provided with a coding.

This system is applied in particular, but not exclusively, to the identification and to the tracing of buried pipes or of other networks concealed in the ground or embedded in civil engineering constructions.

The difficulty of obtaining information regarding the presence, the track and the nature of buried pipes or lines has to do with the fact that, most of the time, nothing is visible externally and that the plans which exist often turn out to be inaccurate, incomplete, or sometimes even wrong.

In order to save time and costs, it is important to be able to detect the presence of such pipes and lines, and to locate them accurately, without digging up the ground or destroying constructions, during subsequent works. Generally, the processes used must be simple to implement by relatively unskilled laborers. Furthermore, the gear for implementing these detection processes must be robust and reliable and its cost must remain less than the investment that would be required in order to expose the pipes or their warning netting by excavation in order to be certain of their presence.

Several processes may be used to detect buried pipes. A first process consists in “visualizing” a metal or nonmetal buried pipe with the aid of an underground radar. However, the costs and the complexity of the systems implemented make these devices unsuited to the practical problems posed.

Electromagnetic detection is the method most used. This electromagnetic detection can be performed by conventional metal detectors, electromagnetic detectors relying on the detection of a signal, and detectors associated with markers.

Conventional metal detectors indiscriminately detect any metal items that are concealed in the ground, without differentiating between the items to be detected and nuisance items.

If the pipe is clad with a coding device comprising electrically conducting elements, such as plates or wires, arranged at specified gaps, and mounted on an insulating support, a detector can detect such elements, but the reading of the code may be disturbed by the nuisance elements concealed in the ground, or else by the nearby presence of several objects comprising coding elements.

Another solution consists in using electromagnetic detectors relying on the detection of a signal. This solution requires the injection of an electrical signal into a pipe or into a concealed cable, or into an associated metal element following the track of a pipe. Such a solution has the drawback of having to partially access the pipe or the associated metal element in order to inject the electrical signal, via boxes installed at regular distances over the line so as to serve as points of access.

In certain cases, it is possible to use a detector with passive signal, relying on the detection of an existing signal. Such is the case for the live cables of the lines of the electricity distribution network and of the telephone network, where a current or a signal is customarily present. The earth is also home to numerous return currents which tend to meet up in metal pipes.

However, the detection of an unloaded live cable is not possible, since only the flowing of a current gives rise to a magnetic field.

However, this detection is random on account of the possibility of variable or zero loads in the case of an electricity distribution network, on account of the very widespread use of twisted cable pairs, so that the “outward” and “return” fields tend to compensate one another.

Detectors associated with semi-active or resonant markers exist. The markers include a passive coil encased in a protective shell made of insulating material, and tuned to a certain frequency. The detector comprises an electromagnetic generator that pulses a range of frequencies and excites the coils. The drawback of such a system resides in the fact that, if one is tracing a pipe, the markers must be buried at regular intervals sufficiently close together as not to lose the pipe, and this entails a high installation cost. Moreover, no indication of direction is given. Finally, even if it is possible to detect a pipe, the identification of the latter is much more complex.

The aim of the invention is to provide a system for detecting and identifying optically invisible objects which are provided with a coding, which is autonomous, that is to say does not require points of access to the object to be detected, which allows definite identification of the object with very fine discrimination, and which is insensitive to the external environment, that is to say which makes it possible to circumvent nuisance elements resulting from the presence of metal objects, or from the conducting nature of certain ground soils.

For this purpose, the system for detecting and identifying optically invisible objects which are provided with a coding, in which each object is provided with coding elements exhibiting the form of a succession of electrically conducting elements of small thickness, which are electromagnetically detectable, each forming a surface of predetermined dimensions and arranged in or on an electrically insulating protective support, these elements being separated from one another by intervals likewise of predetermined value, is characterized in that it comprises an electromagnetic detector including at least one transmission coil and at least one reception coil, which are devised so as to provide the detector with at least two signals representative of the code carried by an object and of its environment, means being envisaged for processing these signals so as to reconstruct the signature of the single code and thus to locate and identify the coded object.

The coding of an object is thus pinpointed several times, by virtue of the various signals representative thereof. From the various signals, the signature of the code is reconstructed by mathematical processing, dispensing with the components of the signals resulting from the presence of metal objects, or from the greater or lesser conductivity of the ground soil.

According to a characteristic of the invention, the detector comprises a computer receiving the various signals and reconstructing the exact code of the object by mathematical methods based for example on independent component analysis or derivatives thereof such as source separation methods.

Furthermore, the detector includes a sensor making it possible to measure its relative displacement and triggering the operations of processing the signals with respect to predetermined distances of displacement. These processes for measuring displacement may be of various kinds (incremental coder, optical measurement, radio link, GPS, etc). A particular mode of embodiment is to link a wheel built in to the detector to an incremental coder which accurately measures its displacement.

This characteristic makes it possible to dispense with the rate of displacement of the detector with respect to the object to be detected and to be identified, since only the detector's displacement value is taken into consideration when carrying out two successive processings.

According to one possibility, the adjustable shift of displacement of the detector between two processing operations is of the order of 4 mm.

It should be made clear that the object to be detected and to be identified may be an object of elongate shape, such as a conduit, on which the coding elements are arranged in linear fashion, one following another, or may be an object of more point-like shape, on which the coding elements are arranged in concentric fashion.

The coding elements may be integrated into the objects to be detected and to be identified by various processes, such as: adhesive bonding, hooping, double or triple extrusion, painting, spraying, injection, fusion etc. When dealing with tubes, the coding elements may be integrated into the tube during their manufacture, but may also be added a posteriori, that is to say after manufacture, by adding a wrapping or a skin integrating the codes.

According to a first form of execution of the invention, the detector comprises a transmission coil and a reception coil, the transmission coil transmitting electromagnetic signals of different frequencies successively and with a small time offset. Under such an assumption, the two signals are obtained successively on being transmitted by the same transmission coil, and are received successively by the same reception coil.

According to another form of execution of the invention, the detector comprises at least one transmission coil and several mutually staggered reception coils.

Various solutions are possible; there may be a transmission coil transmitting a single frequency, the number of signals processed being equal to the number of coils, since each coil receives a signal taking account of its position in space. It is also possible to make a detector which includes several transmitting coils that transmit alternately and whose signals are received by several mutually staggered receiving coils. According to an advantageous form of execution of this

detector, the detector comprises a transmission coil transmitting an electromagnetic signal at a specified frequency and three reception coils arranged along a circle and mutually offset by 90°.

Whatever the number of transmission coils, the latter may simultaneously transmit a signal of fixed frequency, simultaneously signals of different frequencies or successively with small offsets, signals of different frequencies. All the possible combinations may be envisaged.

The resignation and reception coils may be of various shapes: round, ovoid, square, rectangular etc, made by different means: etching or other, and possess various structures: flat or with windings, without the principle of the invention being modified thereby.

According to a particular embodiment, the coils are two-sided flat, etched coils including epoxy supports.

The transmission frequencies may lie within a very wide frequency range depending on the nature of the conducting materials used and the desired difference between the signals perceived by the reception coil or coils.

In so far as the coding elements are based on aluminum, the frequency of the electromagnetic signal transmitted by the transmission coil or coils is of the order of 10 KHz. The transmission and reception coils may be of round shape, or of any other shape, such as ovoid, square, rectangular, orthogonal, without the behavior of the sensor being modified thereby.

In so far as the detector comprises a transmission coil and several reception coils, it is beneficial to arrange a central transmission coil, and to arrange the reception coils in a symmetric fashion, thereby making it possible to exploit knowledge regarding the deviation between the displacement of the operator, that is to say of the sensor, and the axis defined by the pipe, that is to say by the coding.

Anyway, the invention will be clearly understood with the aid of the description which follows, with reference to the appended diagrammatic drawing representing, by way of nonlimiting examples, several forms of execution of this system:

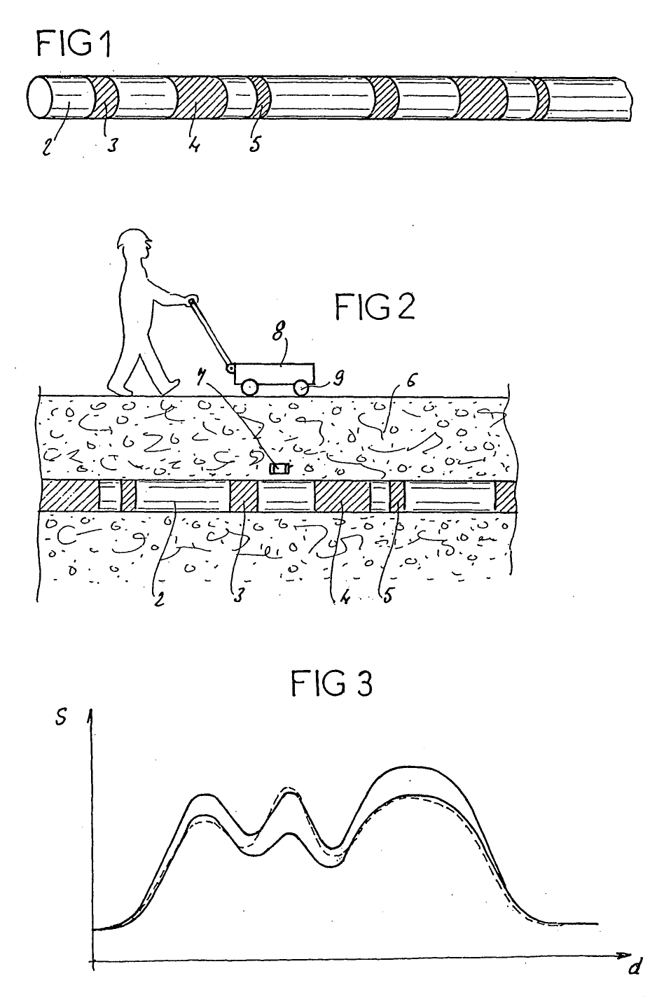

FIG. 1 is a perspective view of a piece of pipe belonging to the system according to the invention;

FIG. 2 is a view of this piece of pipes in the buried position, and in the course of its phase of detection;

FIG. 3 is a view of a curve representing the signals received by three reception coils in the case of detection in accordance with FIG. 2;

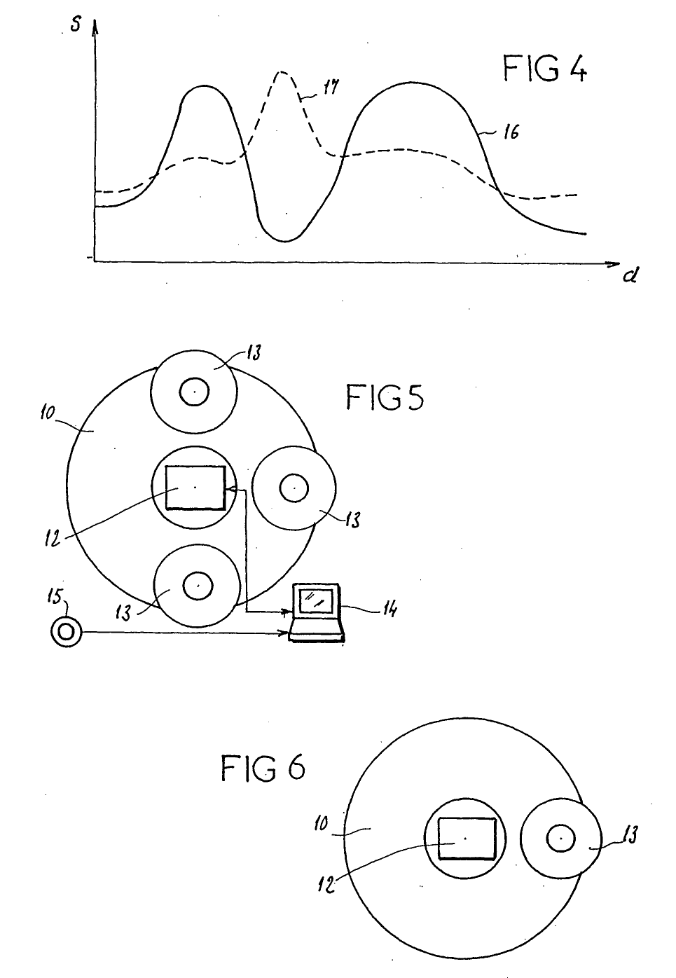

FIG. 4 is a view similar to FIG. 3 after processing of the signals with a view to separating the coding from the nuisance factors;

FIGS. 5 to 7 are three diagrammatic views of three detectors.

FIG. 1 represents a pipe 2, for example a pipe made of synthetic material, clad on its external face with coding elements 3, 4, 5 consisting of bands of conducting material, for example of aluminum, each of specified dimensions, and separated from one another by specified distances. This pipe is intended to be concealed in the earth 6, as shown in FIG. 2, for example at a depth of between 20 cm and 1.20 m.

The system according to the invention is aimed at making it possible to determine the position and the identification of this conduit, even in the presence of nuisance external elements, such as a metal can 7. For this purpose, use is made of a detector 8 mounted for example on one or more wheels 9, and displaceable by an operator.

In the case described, the detector is that represented in FIG. 5, and includes a central transmission coil 10, at the center of which is arranged an electronic card 12, and right around which are arranged three reception coils 13, mutually offset by 90°. In this instance these are double-sided flat, etched coils comprising epoxy supports. The electronic card 12 is linked to a computer 14. To this computer is also linked an incremental coder which indicates the moments at which the processing of the signals received must be performed. The transmission frequency of the coil is of the order of 10 KHz. In practice, the operator displaces the detector on the ground above the pipe 2. The coil transmitting an electromagnetic signal, three distinct signals are received by the three coils 13, these signals being represented in FIG. 3, which is a graph representing along the abscissa the displacement of the detector and along the ordinate the strength of the signal received by each detector. It may be seen that the metal object 7 situated in proximity to the pipe stands out clearly from FIG. 3 where it is identified by the central peak. The mathematical processing of the three signals, for example by a method of independent component analysis makes it possible to reconstruct the curve 17, which corresponds to the curve 16, and to identify the curve 17 which corresponds to the metal object whose presence interfered with the measurement.

If the disturbance was, for example, a code relating to the presence of another pipe, the system also makes it possible to reconstruct the signature of this other code. After the reconstruction of the signatures of the codes, a processing which makes it possible to accurately identify the various codes is implemented and then provides a reliable response as to the nature of the pipes and to the depth at which they are buried.

FIG. 6 represents a variant of the execution of the detector, in which the same elements are designated by the same references as before. In this case, the detector comprises a single transmission coil 10 and a single reception coil 13. In order to exploit two reception signals, the transmission coil transmits electromagnetic signals successively according to differences frequencies.

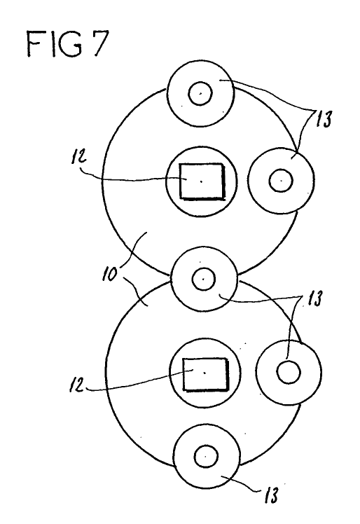

FIG. 7 represents another form of execution of a detector including two transmission coils 10 and five reception coils 13.

As evident from the foregoing, the invention affords a great improvement to the existing technique by providing a system for detecting and identifying optically invisible objects which are provided with a coding, which is autonomous, that is to say does not require any point of access to the object, which allows the detection and the identification of the object by fine discrimination with respect to the environment of the object, and which is very simple for the operator to implement.

As goes without saying, the invention is not limited solely to the forms of execution of this system which are described hereinabove by way of examples, on the contrary it embraces all variants thereof. Thus, in particular, the coils might not be round but square or ovoid, the reception coils might not be mutually offset by 90° in the case of a detector with three coils, or else the reception coils might not be parallel but perpendicular to the transmission coils, without thereby departing from the scope of the invention.

1. A system for detecting and identifying optically invisible objects which are provided with a coding, in which each object (2) is provided with coding elements exhibiting the form of a succession of electrically conducting elements (3, 4, 5) of small thickness, which are electromagnetically detectable, each forming a surface of predetermined dimensions and arranged in or on an electrically insulating protective support, these elements being separated from one another by intervals likewise of predetermined value, characterized in that it comprises an electromagnetic detector (8) including at least one transmission coil (10) and at least one reception coil (13), which are devised so as to provide the detector with at least two signals representative of the code carried by an object and of its environment, means being envisaged for processing these signals so as to reconstruct the signature of the single code and thus to locate and identify the coded object.

2. The system as claimed in claim 1, characterized in that the detector (8) comprises a computer receiving the various signals and reconstructing the exact code of the object by mathematical methods based for example on independent component analysis or derivatives thereof such as source separation methods.

3. The system as claimed in either of claims 1 and 2, characterized in that the detector (8) is associated with a sensor making it possible to measure its relative displacement and triggering an operation of processing the signals received independently of the rate of movement of the operator, such as a wheel (9) associated with an incremental counter (15) triggering an operation of processing the signals received, after displacement of the detector by a predetermined distance.

4. The system as claimed in claim 3, characterized in that the adjustable shift of displacement of the detector (8) between two processing operations is of the order of 4 mm.

5. The system as claimed in one of claims 1 to 4, characterized in that the conducting coding elements (3, 4, 5) on the objects to be detected are integrated into the latter by one of the following processes: adhesive bonding, hooping, double or triple extrusion, painting, spraying, injection, fusion.

6. The system as claimed in one of claims 1 to 5, characterized in that the detector (8) comprises a transmission coil (10) and a reception coil (13), the transmission coil (10) transmitting electromagnetic signals of different frequencies successively and with a small time offset.

7. The system as claimed in one of claims 1 to 5, characterized in that the detector (8) comprises at least one transmission coil (10) and several mutually staggered reception coils (13).

8. The system as claimed in claim 7, characterized in that the detector (8) comprises a transmission coil (10) transmitting an electromagnetic signal at a specified frequency and three reception coils (13) arranged along a circle and mutually offset by 90°.

9. The system as claimed in claims 1 to 8, characterized in that the coils (10, 13) are two-sided flat, etched coils including epoxy supports.

10. The system as claimed in one of claim 1 to 9, characterized in that the frequency of the electromagnetic signal transmitted by the transmission coil or coils is of the order of 10 KHz.
